(19) United States
(12) Patent Application Publication
(10) Pub. No.: US 2012/0262791 A1
(43) Pub. Date: Oct. 18, 2012

(54) MESOPOROUS SILICA FILM, STRUCTURAL BODY HAVING MESOPOROUS SILICA FILM, ANTIREFLECTION FILM, OPTICAL MEMBER, AND METHODS OF PRODUCING THE SAME

(75) Inventors: Masahiko Takahashi, Hachioji-shi (JP); Hirokatsu Miyata, Hadano-shi (JP)

(73) Assignee: CANON KABUSHIKI KAISHA, Tokyo (JP)

(21) Appl. No.: 13/320,447

(22) PCT Filed: Jun. 20, 2011
(86) PCT No.: PCT/JP2011/064615

§ 371 Date: Nov. 14, 2011

(30) Foreign Application Priority Data
Jun. 24, 2010 (JP) 2010-144282
Jun. 14, 2011 (JP) 2011-132193

(51) Int. Cl. C01B 33/10; B05D 5/00; G02B 1/11; B32B 5/32

(52) U.S. Cl. 359/601; 428/312.6; 427/245

(57) ABSTRACT

Provided is a mesoporous silica film, including a structure represented by SiO_{(2-n/2)}Xₙ (where X represents a group formed of at least one kind selected from the group consisting of an alkyl group, a fluorinated alkyl group, and fluorine, n represents an integer of 1 or more and 3 or less) in a surface layer of the mesoporous silica film, in which: an element component ratio (A₁/S₁) of sum of number of carbon atoms and number of fluorine atoms (A₁) to number of silicon atoms (S₁) in the surface layer is 0.1 or more; and an element component ratio (A₂/S₂) of sum of number of carbon atoms and number of fluorine atoms (A₂) to number of silicon atoms (S₂) in an inner layer of the mesoporous silica film is smaller than the element component ratio (A₁/S₁).

### TECHNICAL FIELD

The present invention relates to a mesoporous silica film, a structural body having a mesoporous silica film, an antireflection film having a mesoporous silica film, and an optical member having the antireflection film, and a method of producing a mesoporous silica film, a method of producing a structural body having a mesoporous silica film, a method of producing an antireflection film having a mesoporous silica film, and a method of producing an optical member having the antireflection film. Such antireflection film and optical member can be used particularly in optical instruments such as a camera lens and display apparatuses such as a display.

### BACKGROUND ART

An antireflection film has been known as a technology for reducing the reflection of ambient light at the surface of a camera lens or of a display for indication. As the refractive index of the outermost surface layer of the antireflection film reduces, the antireflection characteristic of the film is generally improved because a difference in refractive index at an interface with air reduces. A magnesium fluoride film having a refractive index of 1.38 has been widely utilized as such outermost surface layer. However, a film material having an additionally low refractive index has been demanded in order that the characteristic of the antireflection film may be additionally improved.

A method involving utilizing a porous film obtained by introducing pores into a film exists as means for realizing a refractive index lower than that of the magnesium fluoride film. In particular, a mesoporous silica film formed of a mesoporous silica material whose pores have diameters in the range of 2 to 50 nm is expected to serve as a low-refractive index layer for an antireflection film because the film is excellent in permeability in a visible light region. NPL 1 describes methods of producing various mesoporous materials and the structures of the materials. PTL 1 describes an antireflection film formed of a mesoporous silica material.

A sol-gel method has been mainly employed as a method of producing a mesoporous silica film because the method is a simple process and the resultant film is excellent in quality. However, a large number of silanol groups generally remain in a porous silica film produced by the sol-gel method, and hence the film has involved the following possibilities. The refractive index of the film may fluctuate in association with the absorption of moisture in the air, or the mesoporous structure of the film may collapse owing to moisture absorption. In PTL 2, the moisture absorption of a mesoporous silica material is suppressed by chemically modifying a silanol group remaining on the surface of a fine pore of the mesoporous silica material with an organic substance having hydrophobicity. In addition, NPL 2 discloses a technology for suppressing adsorption involving forming a nonporous silica layer on the surface of a fine pore of a mesoporous silica film by means of an atomic layer deposition method to block the fine pore.

When a silanol group on the surface of a fine pore is subjected to hydrophobic modification in accordance with the prior art, the entire surfaces of the fine pores present in a mesoporous silica film are subjected to the hydrophobic modification. As a result, a fluctuation in the refractive index of the mesoporous silica film due to its moisture absorption can be suppressed indeed, but the refractive index of the mesoporous silica film itself increases to no small extent. This results from a reduction in porosity due to a state in which hydrophobic modifying groups partially occupy portions that have been voids before the hydrophobic modification. In addition, the method involving producing a nonporous silica thin film by means of the atomic layer deposition method has involved problems in terms of mass productivity and cost because the method requires a large-scale apparatus and its film formation rate is extremely slow.

As described above, upon application of a mesoporous silica film particularly to a low-refractive index layer for an antireflection film, to suppress a fluctuation in refractive index due to moisture absorption at a low cost while suppressing an increase in the refractive index of the mesoporous silica film itself has been a problem.

### CITATION LIST

### Patent Literature

PTL 1: Japanese Patent Application Laid-Open No. 2009-210739
PTL 2: Japanese Patent Application Laid-Open No. 2002-241124

### Non Patent Literature

NPL 1: “Chem. Mater.”, Vol. 20, No. 3, p. 682, 2008
NPL 2: Journal of the American Chemical Society, vol. 128, 2006, p. 11018

### DISCLOSURE OF INVENTION

The present invention has been made in view of such background art. That is, the present invention provides a mesoporous silica film whose refractive index is kept low and fluctuates owing to moisture absorption to a reduced extent by the following approach, a structural body, an antireflection film, and an optical material each having the mesoporous silica film, and methods of producing the same. Hydrophobicity is selectively imparted only to the surface layer of the mesoporous silica film, or a nonporous silica film is formed on the surface of a mesoporous silica layer at a low cost.

According to a first aspect of the present invention, there is provided a mesoporous silica film, including a structure represented by SiO_{(2-n/2)}Xₙ where X represents a group formed of at least one kind selected from the group consisting of an alkyl group, a fluorinated alkyl group, and fluorine, n represents an integer of 1 or more and 3 or less, and, in a case where X represents an alkyl group or a fluorinated alkyl group, the group is allowed to have an unsaturated bond in part of the group in a surface layer as a region to a depth of less than 10 nm from at least one surface of the mesoporous silica film, wherein; an element component ratio (A₁/S₁) of sum of number of carbon atoms and number of fluorine atoms (A₁) to number of silicon atoms (S₁) in the surface layer is 0.1 or more, and an element component ratio (A₂/S₂) of sum of number of carbon atoms and number of fluorine atoms (A₂) to number of silicon atoms (S₂) in an inner layer as a region to a depth of 10 nm or more from the surface of the mesoporous silica film is smaller than the element component ratio (A₁/S₁) of sum of number of carbon atoms and number of fluorine atoms to number of silicon atoms in the surface layer.

According to a second aspect of the present invention, there is provided a structural body having a mesoporous silica film, including a structure represented by SiO_{(2-n/2)}Xₙ where X represents a group formed of at least one kind selected from the group consisting of an alkyl group, a fluorinated alkyl group, and fluorine, n represents an integer of 1 or more and 3 or less, and, in a case where X represents an alkyl group or a fluorinated alkyl group, the group is allowed to have an unsaturated bond in part of the group in a surface layer as a region to a depth of less than 10 nm from the surface of the mesoporous silica film, wherein; an element component ratio (A₁/S₁) of sum of number of carbon atoms and number of fluorine atoms (A₁) to number of silicon atoms (S₁) in the surface layer is 0.1 or more, and an element component ratio (A₂/S₂) of sum of number of carbon atoms and number of fluorine atoms (A₂) to number of silicon atoms (S₂) in an inner layer as a region to a depth of 10 nm or more from the surface of the mesoporous silica film is smaller than the element component ratio (A₁/S₁) of sum of number of carbon atoms and number of fluorine atoms to number of silicon atoms in the surface layer.

According to a third aspect of the present invention, there is provided an antireflection film having a mesoporous silica film, including a structure represented by SiO_{(2-n/2)}Xₙ where X represents a group formed of at least one kind selected from the group consisting of an alkyl group, a fluorinated alkyl group, and fluorine, n represents an integer of 1 or more and 3 or less, and, in a case where X represents an alkyl group or a fluorinated alkyl group, the group is allowed to have an unsaturated bond in part of the group in a surface layer as a region to a depth of less than 10 nm from the surface of the mesoporous silica film, wherein; an element component ratio (A₁/S₁) of sum of number of carbon atoms and number of fluorine atoms (A₁) to number of silicon atoms (S₁) in the surface layer is 0.1 or more, and an element component ratio (A₂/S₂) of sum of number of carbon atoms and number of fluorine atoms (A₂) to number of silicon atoms (S₂) in an inner layer as a region to a depth of 10 nm or more from the surface of the mesoporous silica film is smaller than the element component ratio (A₁/S₁) of sum of number of carbon atoms and number of fluorine atoms to number of silicon atoms in the surface layer.

According to a fourth aspect of the present invention, there is provided a method of producing a treated mesoporous silica film, including:

(1) exposing a mesoporous silica film to an environment having a relative humidity of 80% or more in a reactor in which a relative humidity is controllable to cause insides of fine pores of the mesoporous silica film to adsorb moisture;

(2) introducing steam containing a silicon-containing compound into the reactor in a state in which moisture adsorbs to the insides of the fine pores of the mesoporous silica film; and

(3) treating the mesoporous silica film with the silicon-containing compound and then taking the mesoporous silica film out of the reactor to desorb moisture adsorbing to the insides of the fine pores.

Further features of the present invention will become apparent from the following description of exemplary embodiments with reference to the attached drawings.

### BRIEF DESCRIPTION OF DRAWINGS

FIG. 1 is a schematic sectional view illustrating a structural body having a mesoporous silica film according to Embodiment 1.

FIG. 2 is a schematic sectional view illustrating a structural body having a mesoporous silica film according to Embodiment 2.

FIG. 3 is a schematic view illustrating an example of a binding form of a hydrophobic structure in the structural body having a mesoporous silica film according to Embodiment 1.

FIG. 4 is a schematic view illustrating another example of the binding form of the hydrophobic structure in the structural body having a mesoporous silica film according to Embodiment 1 (example in which a molecule having the hydrophobic structure adsorbed to a mesoporous silica skeleton).

### BEST MODE FOR CARRYING OUT THE INVENTION

Hereinafter, embodiments of the present invention are described in detail.

### Embodiment 1

This embodiment is an embodiment related to a state in which the hydrophobicity of at least part of the surface layer of a mesoporous silica film is higher than that of a region except the surface layer (hereinafter referred to as an “inner layer”).

Various methods exist for evaluation for hydrophobicity. A known evaluation method involving performing the evaluation on the basis of the contact angle of a water droplet can be given as an example of the methods. Alternatively, the evaluation can be performed by an elemental analysis method, mass spectrometry, or the like. Main structural elements in the inner layer of the mesoporous silica film are Si and O. Therefore, for example, when considerable amounts of alkyl groups and fluorine atoms are present in the surface layer, it can be said that the hydrophobicity of the surface layer is higher than that of the inner layer.

The mesoporous silica film according to this embodiment includes a structure represented by SiO_{(2-n/2)}Xₙ (where X represents a group formed of at least one kind selected from an alkyl group, a fluorinated alkyl group, and fluorine, n represents an integer of 1 or more and 3 or less, and, in a case where X represents an alkyl group or a fluorinated alkyl group, the group may have an unsaturated bond in part of the group) in a surface layer as a region to a depth of less than 10 nm from at least one surface of the mesoporous silica film (such structure may be evaluated as a hydrophobic structure). Further, an element component ratio (A₁/S₁) of sum of number of carbon atoms and number of fluorine atoms (A₁) to number of silicon atoms (S₁) in the surface layer is 0.1 or more. In addition, an element component ratio (A₂/S₂) of sum of number of carbon atoms and number of fluorine atoms (A₂) to number of silicon atoms (S₂) in an inner layer formed of a region to a depth of 10 nm or more from the surface of the mesoporous silica film is smaller than the element component ratio (A₁/S₁) of sum of number of carbon atoms and number of fluorine atoms to number of silicon atoms in the surface layer. The expression “sum of number of carbon atoms and number of fluorine atoms to number of silicon atoms” herein employed means (number of carbon atoms+number of fluorine atoms)/(number of silicon atoms). Incidentally, there is a case where the number of carbon atoms or the number of fluorine atoms is zero.

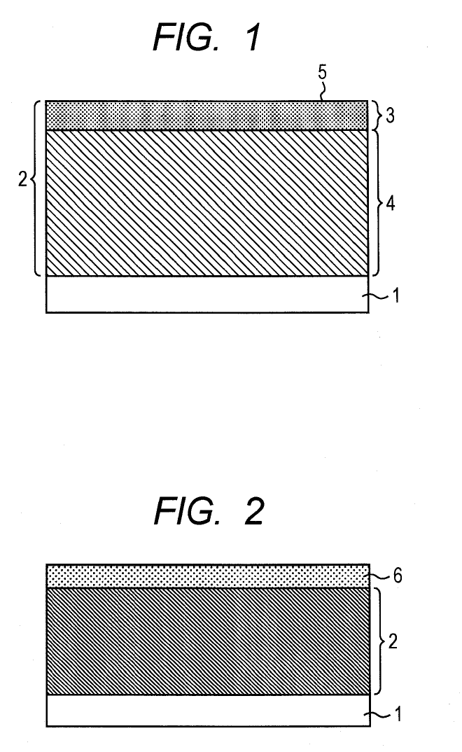

A structural body having the mesoporous silica film of this embodiment is described with reference to a drawing. FIG. 1 is a schematic view illustrating an example of the structural body in this embodiment. In the figure, reference numeral 1 represents a base material, reference numeral 2 represents a mesoporous silica film, reference numeral 3 represents a surface layer, reference numeral 4 represents an inner layer, and reference numeral 5 represents the surface of the mesoporous silica film. The term “surface layer” as used herein refers to a region to a depth of less than 10 nm from the film surface. In addition, the term “inner layer” refers to a region to a depth of 10 nm or more from the film surface.

The use of a translucent base material or the like as the base material can turn the structural body into an optical member. In addition, when the structural body is used as an optical member, the mesoporous silica film 2 can be an antireflection film. It should be noted that an optical member may be formed by integrating the structural body with any other film or the like, or an antireflection film may be formed by, for example, stacking the mesoporous silica film and any other film or the like as required.

For example, the light emission-side substrate of an optical lens or of a display panel is suitable as the base material 1 for forming the mesoporous silica film, and the base material is selected from materials and structures in accordance with applications. A material for the base material is not particularly limited as long as the material has sufficient heat resistance and sufficient chemical resistance against the respective production processes including the formation of the mesoporous silica film, and the material can be selected from, for example, a quartz glass, a no-alkali glass, and a borosilicate glass depending on applications, performance, and cost. In addition, part of an antireflection structure formed of a dielectric multilayer film may be formed on the surface of the base material 1 in advance in order that an antireflection characteristic may be additionally improved. It is preferred that the surface of the base material 1 be sufficiently washed with ultrapure water or the like in advance.

The mesoporous silica film 2 is formed on the base material 1. The term “mesoporous silica film” as used herein refers to a silica porous film having pores whose diameters fall within the range of 2 to 50 nm. The thickness of the mesoporous silica film, which depends on a requested optical characteristic, preferably falls within the range of 50 nm to 200 nm.

The steps of producing the mesoporous silica film preferably include a treatment step to be described later. A method of producing the mesoporous silica film before the treatment is not particularly limited, and the film can be produced by an approach appropriately selected from known approaches such as a sol-gel method, a hydrothermal method, and a vapor phase method. The structure of the mesoporous silica film is not particularly limited either, and for example, the structure described in NPL 1 described above can be used.

Hereinafter, a method of producing the mesoporous silica film involving employing the sol-gel method is described as an example.

First, a sol reaction liquid (precursor sol solution) is produced. With regard to specific materials for the solution, the solution is formed of an organic substance serving as a template for forming void portions, a silica precursor substance as a raw material that forms a silica wall, a solvent, an acid or base catalyst, and water. In addition to those materials, another additive may be further added for the purpose of, for example, adjusting film quality.

Examples of the organic substance include materials that can form molecular assemblies in aqueous solutions such as an ionic surfactant and a nonionic surfactant. The kind and amount of the organic substance are appropriately selected depending on a structure and physical properties (such as a refractive index) needed for the mesoporous silica film because the organic substance is removed by baking to be performed later to function as a template for forming pores.

Examples of the silica precursor substance include substances to be used upon formation of silica by a general sol-gel method. Of those, a silicon halide such as silicon tetrachloride or a silicon alkoxide is preferably used because the silicon halide or the silicon alkoxide has high reactivity and is excellent in dispersion uniformity in the sol reaction liquid. Specific examples of the silicon alkoxide include tetramethoxysilane, tetraethoxysilane, and tetrapropoxysilane.

Although a wide range of solvents is applicable as the solvent, an alcohol is preferably used. The alcohol is not particularly limited as long as the alcohol has compatibility with each of the organic substance and the silicon alkoxide described above, and examples of the alcohol include methanol, ethanol, 2-propanol, and 1-propanol. Those alcohols may each be used alone, or multiple kinds thereof may be used as a mixture.

An acid or a base is used as the catalyst for forming silica by subjecting the silica precursor substance to hydrolysis and dehydration condensation. Specific examples of the catalyst include hydrochloric acid, acetic acid, nitric acid, sulfuric acid, sodium hydroxide, ammonia, and aqueous solutions thereof. Of those, an acid such as hydrochloric acid, acetic acid, nitric acid, or sulfuric acid, or an aqueous solution of any one of the acids is more preferred.

Water needed for the hydrolysis of the silicon alkoxide may be added in the form of an aqueous solution of the above-mentioned catalyst, or water may be separately added for the hydrolysis. Alternatively, moisture in air may be taken in by advancing the stirring of the sol reaction liquid in an open container. In that case, the state of a silica oligomer as the silica precursor in the precursor sol solution changes depending on whether a stirring time is long or short, and the change affects the structure of the mesoporous silica film to be obtained. Accordingly, the stirring time is appropriately determined depending on the target structure and target thickness of the mesoporous silica film.

The sol reaction liquid thus obtained is applied onto the base material. A method for the application is not particularly limited, and examples of the method include a spin coating method, a dip coating method, and a spray coating method. Conditions for the application are also appropriately determined in consideration of, for example, the target thickness and target refractive index of the mesoporous silica film. In the case of the production by the sol-gel method, the structure is often formed upon evaporation of the solvent in the application step.

Next, the resultant applied film is dried. As a result, an unnecessary solvent evaporates, and the condensation reaction of the silica wall progresses to some extent. A method for the drying is not particularly limited, and examples of the method include heating with a hot plate or a drying furnace, and still standing in a thermostat for a predetermined time period. An optimum drying method has only to be selected depending on, for example, a material to be used, a requested structure, and the efficiency of the drying process.

The dried applied film is baked with an electric furnace or the like. In a temperature increase process in the baking, the condensation reaction of the silica wall progresses. In addition, when the temperature of the applied film reaches a certain temperature or more, the organic substance in the applied film is removed by the baking, and hence pores are formed. As a result, a mesoporous silica film having a high porosity is obtained.

A baking temperature at this time is preferably 500° C. or less. When the baking is performed at a temperature higher than 500° C., the porosity remarkably reduces in association with excessive contraction of the film, and hence a reducing effect on the refractive index exerted by the introduction of the pores becomes insufficient in some cases. In addition, the baking at a temperature higher than 500° C. may cause a crack depending on a material for, or the structure of, the silica porous film.

The mesoporous silica film thus obtained functions as a low-refractive index layer in an antireflection film by optimizing various conditions such as a material and a production method for the film, and the structure of the film depending on other members such as the base material and a ground layer. In particular, when the porosity is 45% or more, a refractive index at a wavelength of 550 nm is about 1.25 or less, and hence the film can serve as the outermost surface layer of a multilayer-based antireflection structure to exert excellent characteristics on assorted glass materials.

The mesoporous silica film 2 of this embodiment is characterized by being formed of the surface layer 3 as a region to a depth of less than 10 nm from the surface 5 and the inner layer 4 as a region to a depth of 10 nm or more from the surface. The surface layer 3 shows strong hydrophobicity. It should be noted that there is no absolute need to provide a clear interface between the surface layer 3 and the inner layer 4.

Not only a mesoporous silica structure as a basic skeleton but also a structure (hydrophobic structure) represented by SiO_{(2-n/2)}Xₙ is present in the surface layer 3. In the formula, X represents a group formed of at least one kind selected from an alkyl group, a fluorinated alkyl group, and fluorine. Here, some of the bonds in the alkyl group may each be an unsaturated bond. That is, the “alkyl group” as used herein is a concept including a chain saturated aliphatic hydrocarbon group, a chain unsaturated aliphatic hydrocarbon group, a cyclic saturated aliphatic hydrocarbon group, a cyclic unsaturated aliphatic hydrocarbon group, and a group obtained by combining these groups. n indicates a modification amount for one silicon atom in the hydrophobic structure with regard to the modifying group represented by X described above and represents an integer of 1 to 3. As shown in an example (f) or (g) of the hydrophobic structure to be described later, X may be formed of two or more kinds of modifying groups. It should be noted that the representation “SiO_{(2-n/2)}Xₙ” represents the following. On the precondition that O is covalently bonded to Si in the skeleton (SiO skeleton) of the mesoporous silica structure (or Si of a portion except the hydrophobic structure in a silicon-containing compound that exists while contacting the mesoporous silica structure), the bonded O is present half and half in the structure represented by SiO_{(2-n/2)}Xₙ and the skeleton of the mesoporous silica structure (or the portion except the hydrophobic structure in the silicon compound). Therefore, the structure can be represented as SiO₍₄₋ₖ₎Xₖ (where k represents an integer of 1 or more and 3 or less) in accordance with an additionally general form of representation of a group (the number of bonding hands is 1 or more and 3 or less). Examples of the hydrophobic structure are generally represented as follows.

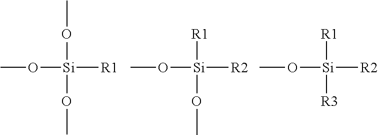

In the formulae, R1, R2, and R3 each independently represent a chain saturated aliphatic hydrocarbon group, a chain unsaturated aliphatic hydrocarbon group, a cyclic saturated aliphatic hydrocarbon group, a cyclic unsaturated aliphatic hydrocarbon group, a group obtained by combining these groups, a fluorine-containing hydrocarbon group, or fluorine. Further, R1 and R2, and R2 and R3 may be bonded to each other to form a cyclic structures, respectively.

When the hydrophobic structure is formed so as to be represented by SiO_{(2-n/2)}Xₙ, the hydrophobic structure is fixed in a mesoporous silica skeleton with good affinity, and a suppressing effect on the adsorption of moisture from the outside is exerted. At this time, the above-mentioned hydrophobic structure may have a covalent bond with the mesoporous silica skeleton, or a molecule including the above-mentioned hydrophobic structure may be fixed in the surface layer by, for example, a hydrogen bond or physical adsorption.

Examples of the hydrophobic structure are shown below. However, the present invention is not limited to these chemical species.

(1) In the case of n=1

An example of the hydrophobic structure in the case of n=1 is as follows.

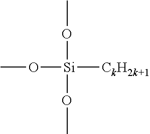

(k represents an integer of 1 or more and 18 or less)

A more specific example thereof is as follows.

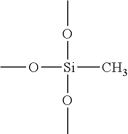

Other examples thereof are as follows.

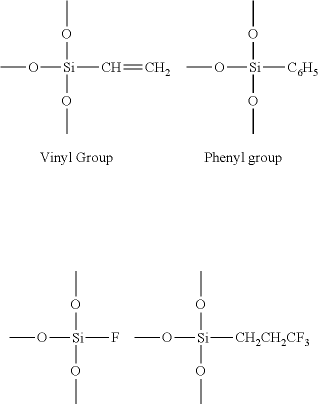

(2) In the case of n=2

An example of the hydrophobic structure in the case of n=2 is as follows.

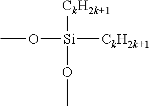

(k represents an integer of 1 or more and 18 or less)

A more specific example thereof is as follows.

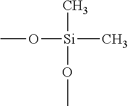

Other examples thereof are as follows.

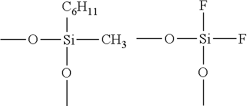

(3) In the case of n=3

Examples of the hydrophobic structure in the case of n=3 are as follows.

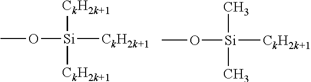

(each k represents an integer of 1 or more and 18 or less)

More specific examples thereof are as follows.

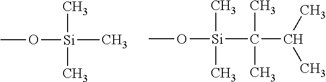

Other examples thereof are as follows.

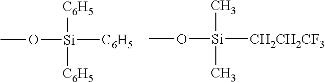

In addition, the molecule including the above-mentioned hydrophobic structure (silicon-containing compound) is, for example, a linear or cyclic alkylsiloxane. An Example of the cyclic alkylsiloxane is as follows.

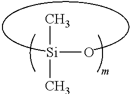

(m represents an integer of 3 or more and 20 or less)

More specific examples thereof are as follows.

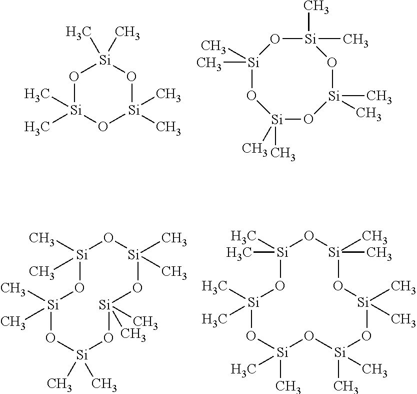

It should be noted that m preferably represents an integer of 6 or more in terms of prevention of desorption.

The above-mentioned hydrophobic structure introduced into the surface layer of the mesoporous silica film can be observed through the analysis of the surface layer by, for example, time-of-flight secondary ion mass spectrometry (hereinafter referred to as “TOF-SIMS”).

The amount of the hydrophobic structure in the surface layer 3 is specified by an element ratio between silicon as a main element that forms the mesoporous silica skeleton, and carbon and/or fluorine responsible for the expression of hydrophobicity in the hydrophobic structure. At this time, an element component ratio (A₁/S₁) of sum of number of carbon atoms and number of fluorine atoms (A₁) to number of silicon atoms (S₁) in the surface layer 3 is 0.1 or more, preferably 0.2 or more. When the element ratio (A₁/S₁) of sum of number of carbon atoms and number of fluorine atoms to number of silicon atoms is less than 0.1, sufficient hydrophobicity cannot be exerted on the adsorption of moisture from the outside, and as a result, a fluctuation in the refractive index of the mesoporous silica film due to its moisture absorption occurs in some cases. It should be noted that the element ratio between silicon, and carbon and/or fluorine in the present invention can be calculated from data measured by, for example, X-ray photoelectron spectroscopy.

The microscopic porosity of the surface layer 3 of the mesoporous silica film 2 is reduced by introducing such hydrophobic structure as described above into the surface layer 3. However, the thickness of the surface layer 3 is less than 10 nm, which is sufficiently thin, and hence an influence of an increase in refractive index in association with the reduction in the porosity of the surface layer 3 on an optical characteristic of the entire film is extremely small. As a result, the hydrophobic structure introduced into the surface layer 3 does not largely affect the antireflection characteristic of the antireflection film.

On the other hand, an element component ratio (A₂/S₂) of sum of number of carbon atoms and number of fluorine atoms (A₂) to number of silicon (S₂) in the inner layer 4 as a region to a depth of 10 nm or more from the surface is made smaller than the element component ratio (A₁/S₁) of sum of number of carbon atoms and number of fluorine atoms to number of silicon atoms in the surface layer. As a result, an increase in the refractive index of the inner layer 4 in association with the introduction of the hydrophobic structure into the surface layer 3 can be suppressed, and hence the function of the mesoporous silica film 2 as a low-refractive index layer in the antireflection film can be maintained.

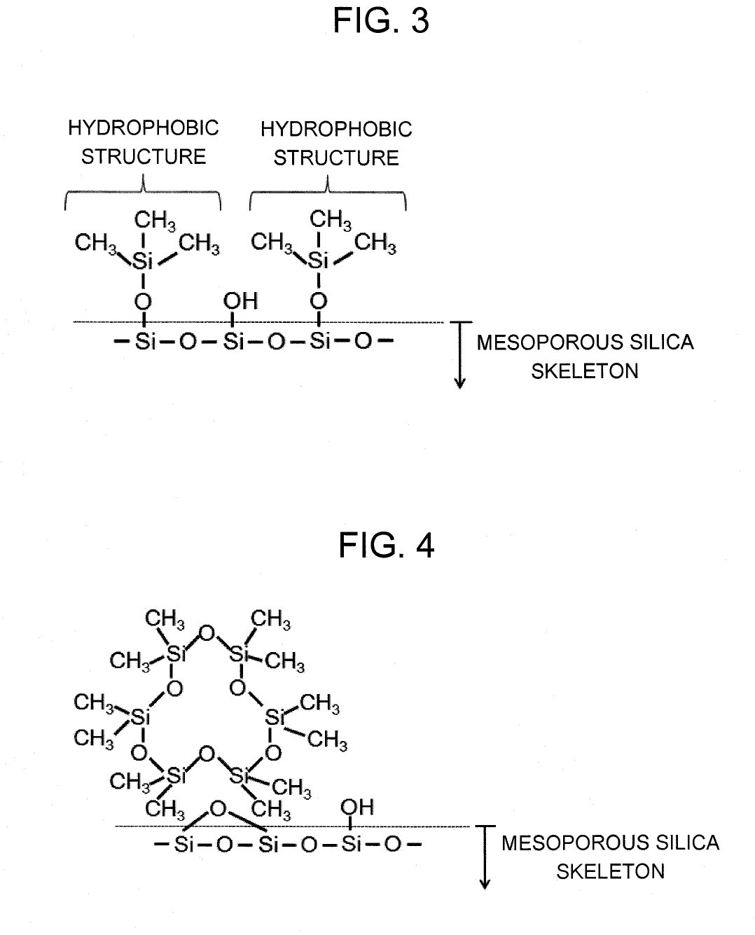

Here, FIG. 3 illustrates an example of a binding form of the mesoporous silica skeleton and the hydrophobic structure. In the figure, the structure below the dotted line represents the mesoporous silica skeleton, and the OH group and the hydrophobic structures (in this case, —OSi(CH₃)₃ groups) shown above the dotted line are bound to the mesoporous silica skeleton.

Further, FIG. 4 illustrates an example in which a molecule including the hydrophobic structure is fixed in the surface layer by, for example, a hydrogen bond or physical adsorption. As is the case in FIG. 3, the structure below the dotted line represents the mesoporous silica skeleton, and in this example, dodecamethylcyclohexasiloxane is adsorbed to the surface of the mesoporous silica skeleton.

In the present invention, through the following approach, a fluctuation in refractive index in association with moisture absorption is suppressed while the refractive index of the mesoporous silica film 2 is kept low. As described above, stronger hydrophobicity is imparted to the surface layer 3 by the introduction of the hydrophobic structure, and on the other hand, the introduction of the hydrophobic structure into the inner layer 4 is suppressed. This is because of the following reason. The adsorption and desorption of moisture in the mesoporous silica film 2 are performed mainly through the surface 5 of the film, and hence the moisture absorption of the entire mesoporous silica film can be suppressed by imparting sufficient hydrophobicity to the surface layer 3.

In particular, the element component ratio (A₂/S₂) of sum of number of carbon atoms and number of fluorine atoms to number of silicon atoms in the inner layer 4 of the mesoporous silica film is preferably 25% or less, more preferably 10% or less of the element component ratio (A₁/S₁) of sum of number of carbon atoms and number of fluorine atoms to number of silicon atoms in the surface layer 3. When the element component ratio (A₂/S₂) in the inner layer 4 is larger than 25% of the element component ratio (A₁/S₁) in the surface layer 3, the extent to which the refractive index increases owing to the inclusion of the hydrophobic structure into the inner layer may enlarge. As a result, the function of the mesoporous silica film 2 including the surface layer 3 as an outermost surface low-refractive index layer in the antireflection film may remarkably reduce. Furthermore, from the viewpoint of preventing increase of refractive index by the inclusion of the hydrophobic structure into the inner layer, it is preferred that the element component ratio (A₂/S₂) in the inner layer 4 is 1 or less.

In addition, according to the invention by the inventors of the present invention, the above-mentioned mesoporous silica film having the hydrophobic structure selectively introduced only into its surface can be produced by an extremely simple method. Hereinafter, the method is described by taking an example.

First, the insides of the fine pores of the mesoporous silica film are caused to adsorb a sufficient amount of moisture. An approach for the foregoing is as described below. A reactor in which a relative humidity is controllable and which can be hermetically sealed is prepared, and then the reactor is hermetically sealed in a state in which the mesoporous silica film to be treated is placed in the reactor. After that, the relative humidity in the reactor is increased to preferably 80% or more, more preferably 90% or more. As a result of the operation, the mesoporous silica film is exposed to an environment having a relative humidity of 80% or more, and hence water molecules adsorb to the insides of the fine pores of the mesoporous silica film.

The following approach may be adopted because a similar effect can be obtained. The pressure in a reactor whose pressure can be reduced is reduced in a state in which the mesoporous silica film to be treated and a small amount of water are caused to coexist in the reactor, and then the reactor is sealed. In this approach, a gas having the highest partial pressure in the reactor is water vapor, and hence the adsorption of the water molecules to the insides of the fine pores of the mesoporous silica film is achieved in an additionally efficient fashion.

Next, as required, the temperature in the reactor is increased while the relative humidity in the reactor is kept constant. The foregoing has not only an accelerating effect on the adsorption of moisture to the insides of the fine pores but also an improving effect on the reactivity of the silicon-containing compound (which may be referred to as a “hydrophobic modifying material” in this embodiment) in a reaction after the adsorption. It should be noted that the temperature in the reactor is preferably increased at a sufficiently slow rate of temperature increase lest condensation should occur on the surface of the mesoporous silica film.

By the above-mentioned approach, while a state in which a sufficient amount of moisture adsorbs to the insides of the fine pores of the mesoporous silica film in the hermetically sealed reactor is maintained, steam containing the hydrophobic modifying material is introduced into the reactor so that the mesoporous silica film may be subjected to a hydrophobic treatment. The hydrophobic modifying material is not particularly limited as long as the material is a chemical substance capable of introducing any one of such structures as shown in the foregoing chemical formulae (a) to (g) into the mesoporous silica film after the treatment.

For example, a compound represented by SiXₙY₍₄₋ₙ₎ (where X represents a group formed of at least one kind selected from an alkyl group, a fluorinated alkyl group, and fluorine, Y represents a group formed of one or more kinds selected from chlorine, bromine, alkoxy group and a hydroxyl group, n represents an integer of 1 to 3, and, in a case where X represents an alkyl group or a fluorinated alkyl group, the group may have an unsaturated bond in part of the group) is suitably used.

It should be noted that the steam may contain multiple kinds of hydrophobic modifying materials.

Specific examples of the hydrophobic modifying material are listed below.

(1) Examples of a hydrophobic modifying material for introducing the hydrophobic structure in the case of n=1

Methyltrichlorosilane, methyltrimethoxysilane, methyltriethoxysilane, methyltripropoxysilane, methyltriphenoxysilane, ethyltrimethoxysilane, ethyltriethoxysilane, n-propyltrimethoxysilane, n-propyltriethoxysilane, isobutyltrimethoxysilane, isobutyltriethoxysilane, n-hexyltrimethoxysilane, n-hexyltriethoxysilane, n-octyltriethoxysilane, n-decyltrimethoxysilane, vinyltrimethoxysilane, vinyltriethoxysilane, phenyltrichlorosilane, phenyltrimethoxysilane, phenyltriethoxysilane, triethoxyfluorosilane, trifluoropropyltrimethoxysilane

(2) Examples of a hydrophobic modifying material for introducing the hydrophobic structure in the case of n=2

Dimethyldichlorosilane, dimethyldimethoxysilane, dimethyldiethoxysilane, diethyldimethoxysilane, diethyldiethoxysilane, diisopropyldimethoxysilane, diisopropyldiethoxysilane, diisobutyldimethoxysilane, diisobutyldiethoxysilane, cyclohexylmethyldimethoxysilane, dimethoxydifluorosilane, diethoxydifluorosilane

(3) Examples of a hydrophobic modifying material for introducing the hydrophobic structure in the case of n=3

Trimethylchlorosilane, trimethylmethoxysilane, hexamethyldisilazane, triethylchlorosilane, triethylethoxysilane, triphenylchlorosilane, n-octyldimethylchlorosilane, t-butyldimethylchlorosilane

It should be noted that any of those hydrophobic modifying materials may be fixed to the mesoporous silica skeleton by eliminating part of the material, or may be caused to adsorb to the mesoporous silica skeleton without changing the structure of the material.

After a lapse of a predetermined reaction time, the mesoporous silica film is taken out of the reactor. After that, the water molecules adsorbing to the inside of the mesoporous silica film are desorbed by, for example, heating and/or pressure reduction.

The mesoporous silica film having the hydrophobic structure selectively introduced only into its outermost surface can be obtained by performing the foregoing treatments. Although the mechanism for the foregoing has not been completely elucidated yet, the mechanism is assumed to be as described below. When the surfaces of the fine pores in the porous film are caused to adsorb a sufficient amount of water molecules in advance, the subsequent treatment with the steam of the hydrophobic modifying material does not reach the inside of the porous film, and as a result, the hydrophobic structure is selectively introduced only into the surface layer.

According to this embodiment, there can be provided a mesoporous silica film whose refractive index is kept low and fluctuates owing to moisture absorption to a reduced extent by selectively imparting hydrophobicity only to the surface layer of the mesoporous silica film, and a method of producing the film.

### Embodiment 2

This embodiment is an embodiment related to, for example, a method of producing a mesoporous silica film including the step of forming a nonporous silica layer as the surface layer of the mesoporous silica film at a low cost.

This embodiment has some points in common with Embodiment 1 such as a point that a treatment with steam containing a silicon compound is performed. Accordingly, the description of the same points as those of Embodiment 1 may be omitted.

FIG. 2 is a schematic view illustrating an example of a structural body in this embodiment. In FIG. 2, reference numeral 1 represents a base material, reference numeral 2 represents a mesoporous silica film, and reference numeral 6 represents a nonporous silica layer. A portion except the nonporous silica layer 6 is the same as that of Embodiment 1, and hence its description is omitted. In addition, with regard to a method of producing the structural body as well, only a portion different from that of Embodiment 1 is described.

In the method of producing the structural body of this embodiment, the step of baking the mesoporous silica film is preferably performed at a relatively low temperature. The step is preferably performed at not more than 170° C. as a lower limit temperature at which a weakly hydrogen-bonded silanol group undergoes a dehydration reaction. The foregoing intends to improve the ease with which moisture enters fine pores in the step of selectively forming the nonporous silica layer on the surface of the film to be described later. When the baking is performed at an excessively high temperature, the hydrophilicity of a fine pore surface is lost owing to the reduction of the number of silanol groups, and hence the selective formation of the silica layer on the surface of the film is hindered in some cases. At a temperature of 170° C. or less, complete removal of the organic substance is not achieved, and the organic substance remains in a trace amount in some cases. However, the remaining substance poses no problems because the complete removal can be achieved at the time of high-temperature baking to be performed later.

Next, the nonporous silica layer 6 is selectively formed on the surface of the mesoporous silica film so that the surface openings of the meso fine pores may be clogged and a fluctuation in refractive index due to the adsorption of moisture from an external environment may be suppressed. The method of the present invention for achieving the object is as described below. First, the mesoporous silica film produced by the above-mentioned step is placed under a high humidity, specifically, a relative humidity of 80% or more so that the insides of its pores may be caused to adsorb moisture. In this state, the hydrolysis reaction of a silica source is caused on the surface of the film so that the silica layer may be formed. A single substance or mixture having a structure represented by SiA₄ (where A represents a chlorine, a bromine or an alkoxy group) is used as the silica source to be used, and the silica source is introduced from a vapor phase into a high-humidity container in which the mesoporous silica film produced in the above-mentioned step is placed. The silica source introduced from the vapor phase can access only the surface of the mesoporous silica film whose surface is covered with moisture or whose fine pores are completely filled with moisture, and hence the silica layer is formed only on the surface. When the thickness of the nonporous silica layer to be formed is excessively large, the refractive index of the film increases. In addition, when the thickness is excessively small, a blocking effect on moisture reduces. Accordingly, the thickness is determined in consideration of the final refractive index and the moisture-blocking effect. The thickness preferably falls within the range of 10 nm to 50 nm, and the thickness can be controlled depending on the vapor pressure and reaction time of the silica source introduced from the vapor phase. When the vapor pressure of the silica source is low, means for heating the silica source to be introduced is appropriately provided.

In this state, the silica formed on the surface still contains large amounts of moisture and silanol groups, and the insides of the fine pores of the mesoporous silica film as a ground also contain a large amount of moisture. Accordingly, the step of treating the entirety of the film at a high temperature to remove moisture is subsequently needed. The high-temperature treatment step must be performed at a temperature higher than that of the surfactant-removing step described in the foregoing. This is because of the following reasons. The silanol concentration in the silica layer formed on the surface should be reduced to the extent possible, and the number of sites to which moisture or the like adsorbs should be removed to the extent possible by reducing the number of voids. An investigation conducted by the inventors of the present invention has found that when baking is performed at not less than 170° C. at which a dehydration reaction from a weakly hydrogen-bonded silanol group occurs, a suppressing effect on an increase in refractive index due to moisture adsorption after the baking becomes remarkable. When the baking step is performed at a temperature of 300° C. or more, dehydration from a strongly hydrogen-bonded silanol group also progresses, and hence the hydrophilicity of the nonporous silica layer formed on the surface further weakens. At the same time, the number of voids reduces. As a result, a refractive index-stabilizing effect increases. When a rate of temperature increase upon performance of the baking step is excessively high, the dehydration densification of the silica layer on the surface quickly occurs, and hence the desorption of moisture that has been introduced into the fine pores of the mesoporous silica film as a ground is inhibited at the time of a reaction with the silica source in some cases. Accordingly, the rate of temperature increase is appropriately set to an optimum value. In order that the reliability with which moisture is removed may be improved, such a temperature increase profile that the film is held at a constant temperature of 170° C. or less for several hours may be set. When the high-temperature treatment step is performed, a dehydration reaction from a silanol group in the mesoporous silica film as a ground that has been initially baked only at a temperature as low as 170° C. or less is also promoted, and hence the film is of such a structure as to adsorb moisture in an additionally hard manner. When the heat resistance of the base material is sufficiently high, baking at a treatment temperature of 500° C. or more in a vacuum is preferred for the stabilization of the refractive index because the desorption of moisture from an isolated silanol group and the densification of the film further progress. However, the contraction of the mesoporous silica layer also becomes remarkable, and hence the refractive index tends to increase. Accordingly, the treatment temperature must be set in simultaneous consideration of the influences of both of the contraction and the increase.

The mesoporous silica film thus obtained functions as a low-refractive index layer in an antireflection film by optimizing various conditions such as a material and a production method for the film, and the structure of the film depending on other members such as the base material and the ground layer. In particular, when the porosity is 45% or more, a refractive index at a wavelength of 550 nm is about 1.25 or less, and hence the film can serve as the outermost surface layer of a multilayer-based antireflection structure to exert excellent characteristics on assorted glass materials. Even when the nonporous silica layer formed on the surface is placed under a high humidity, the layer serves to block the adsorption of chemical species typified by moisture to the mesoporous silica fine pores inside the layer to stabilize the refractive index even under a harsh condition.

The structure of the coating of a two-layer configuration of the mesoporous silica film of the present invention and the nonporous silica layer formed on the film can be confirmed by, for example, the observation of a section with an electron microscope.

The production method of the present invention described above is a steam treatment. Accordingly, particularly when an antireflection film of interest is, for example, a lens curved surface, the entirety of the curved surface can be treated uniformly and simply. In addition, the method enables one to perform a treatment on a large number of antireflection films in one stroke, and hence has a large merit in terms of a production cost.

### EXAMPLES

### Example 1

2.6 Grams of a tetraalkoxysilane, 0.7 g of a block copolymer (Pluronic P123, manufactured by BASF), 13 g of 1-propanol, and 1.35 g of a 0.01-M aqueous solution of hydrochloric acid were mixed and stirred. Thus, a sol reaction liquid was obtained. The sol reaction liquid was applied by a dip coating method onto a quartz substrate that had been washed with ultrapure water. Thus, an applied film was obtained.

After that, the substrate was baked in an electric furnace at 400° C. for 4 hours. Thus, a mesoporous silica thin film was obtained.

Next, the mesoporous silica thin film was left at rest in a reactor having a temperature of 25° C. and a relative humidity of 40%, and then the reactor was hermetically sealed. In the state, the relative humidity in the reactor was increased to 90%, and then the temperature in the reactor was increased up to 60° C. at a rate of 0.1° C./min. While the temperature and the relative humidity in the reactor were kept at 60° C. and 90%, respectively, the steam of t-hexyldimethylchlorosilane represented by the following structural formula (1) was introduced into the reactor, and then a hydrophobic treatment was performed for 10 hours.

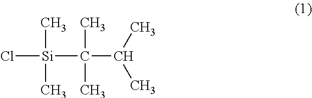

After that, the mesoporous silica thin film was taken out of the reactor, and was then subjected to a treatment for removing adsorbed water at 120° C. for 2 hours.

The mesoporous silica film was evaluated for its refractive index and thickness by spectroscopic ellipsometry. As a result, the film had a refractive index at a wavelength of 550 nm of 1.24 and a thickness of 110 nm. The mesoporous silica film was placed in a thermo-hygrostat under a 60° C., 90% RH environment. After a lapse of 100 hours, the film was left at rest under a room-temperature environment for an additional twenty-four hours. Even after that, nearly no fluctuation in refractive index was observed.

After the surface of the mesoporous silica film had been sufficiently washed with ultrapure water, the outermost surface was etched by ion sputtering by about 1 nm for the purpose of removing the contamination of the outermost surface layer. In the state, the elemental analysis of the surface layer was performed by X-ray photoelectron spectroscopy. As a result, an element ratio (A₁/S₁) of carbon to silicon in the surface layer was 0.3. The surface layer was analyzed for a chemical species present therein by TOF-SIMS. As a result, the presence of a hydrophobic structure derived from the above-mentioned structural formula (1) was confirmed.

In addition, the elemental analysis of the inner layer was performed after the etching had been further performed by ion sputtering in a depth direction by 20 nm. As a result, an element ratio (A₂/S₂) of carbon to silicon in the inner layer was 0.05 or less. The inner layer was analyzed for a chemical species present therein by TOF-SIMS. As a result, the presence of the hydrophobic structure derived from the above-mentioned structural formula (1) was not confirmed.

### Example 2

2.6 Grams of a tetraalkoxysilane, 0.7 g of a block copolymer (Pluronic P123, manufactured by BASF), 13 g of 1-propanol, and 1.35 g of a 0.01-M aqueous solution of hydrochloric acid were mixed and stirred. Thus, a sol reaction liquid was obtained. The sol reaction liquid was applied by a dip coating method onto a quartz substrate that had been washed with ultrapure water. Thus, an applied film was obtained.

After that, the substrate was baked in an electric furnace at 400° C. for 4 hours. Thus, a mesoporous silica thin film was obtained.

Next, the mesoporous silica thin film and 5 mL of pure water were left at rest in a vacuum reactor, and then the vacuum reactor was hermetically sealed. In the state, the pressure in the vacuum reactor was reduced with a vacuum pump, and then the vacuum reactor was sealed. Next, the steam of t-hexyldimethylchlorosilane represented by the structural formula (1) used in Example 1 was introduced into the vacuum reactor, and then a hydrophobic treatment was performed for 10 hours.

After that, the inside of the vacuum reactor was sufficiently flowed with nitrogen. Then, the mesoporous silica thin film was taken out and subjected to a treatment for removing adsorbed water at 120° C. for 2 hours.

The mesoporous silica film was evaluated for its refractive index and thickness by spectroscopic ellipsometry. As a result, the film had a refractive index at a wavelength of 550 nm of 1.24 and a thickness of 112 nm. The mesoporous silica film was placed in a thermo-hygrostat under a 60° C., 90% RH environment. After a lapse of 100 hours, the film was left at rest under a room-temperature environment for an additional twenty-four hours. Even after that, nearly no fluctuation in refractive index was observed.

The surface layer and inner layer of the mesoporous silica film were each chemically analyzed in the same manner as in Example 1. As a result, an element ratio (A₁/S₁) of carbon to silicon in the surface layer was 0.3. The surface layer was analyzed for a chemical species present therein by TOF-SIMS. As a result, the presence of the hydrophobic structure derived from the above-mentioned structural formula (1) was confirmed.

In addition, an element ratio (A₂/S₂) of carbon to silicon in the inner layer was 0.05 or less. The inner layer was analyzed for a chemical species present therein by TOF-SIMS. As a result, the presence of the hydrophobic structure derived from the above-mentioned structural formula (1) was not confirmed.

### Comparative Example 1

2.6 Grams of a tetraalkoxysilane, 0.7 g of a block copolymer (Pluronic P123, manufactured by BASF), 13 g of 1-propanol, and 1.35 g of 0.01-M hydrochloric acid were mixed and stirred. Thus, a sol reaction liquid was obtained. The sol reaction liquid was applied by a dip coating method onto a quartz substrate that had been washed with ultrapure water. Thus, an applied film was obtained. After the substrate including the applied film had been dried at room temperature, the substrate was baked in an electric furnace at 400° C. for 4 hours. Thus, a mesoporous silica thin film was obtained.

The mesoporous silica film was evaluated for its refractive index and thickness in the same manner as in Example 1. As a result, the film had a refractive index at a wavelength of 550 nm of 1.23 and a thickness of 110 nm. The mesoporous silica film was placed in a thermo-hygrostat under a 60° C., 90% RH environment. After a lapse of 100 hours, the film was left at rest under a room-temperature environment for 24 hours. After that, the refractive index was measured again. As a result, the refractive index at a wavelength of 550 nm increased to 1.27.

The surface layer and inner layer of the mesoporous silica film were each chemically analyzed in the same manner as in Example 1. As a result, an element ratio of carbon to silicon in each of the surface layer and the inner layer was 0.01 or less.

The foregoing showed that the refractive index of the mesoporous silica film into which no hydrophobic structure had been introduced fluctuated owing to moisture absorption to no small extent.

### Comparative Example 2

A mesoporous silica thin film was obtained in the same manner as in Comparative Example 1.

Next, the mesoporous silica thin film was left at rest in a reactor having a temperature of 25° C. and a relative humidity of 40%, and then the reactor was hermetically sealed. In the state, the temperature in the reactor was increased up to 60° C. at a rate of 0.1° C./min. After that, while the temperature and the relative humidity in the reactor were kept at 60° C. and 40%, respectively, the steam of t-hexyldimethylchlorosilane represented by the structural formula (1) above was introduced into the reactor, and then a hydrophobic treatment was performed for 10 hours. After that, the mesoporous silica thin film was taken out of the reactor, and was then subjected to a treatment for removing adsorbed water at 120° C. for 2 hours.

The mesoporous silica film was evaluated for its refractive index and thickness in the same manner as in Example 1. As a result, the film had a refractive index at a wavelength of 550 nm of 1.32 and a thickness of 110 nm. The mesoporous silica film was placed in a thermo-hygrostat under a 60° C., 90% RH environment. After a lapse of 100 hours, the film was left at rest under a room-temperature environment for 24 hours. Even after that, nearly no fluctuation in refractive index was observed.

The surface layer and inner layer of the mesoporous silica film were each chemically analyzed in the same manner as in Example 1. As a result, an element ratio (A₂/S₂) of carbon to silicon in the surface layer was 0.25. In addition, an element ratio (A₂/S₂) of carbon to silicon in the inner layer was 0.25. In addition, analysis by TOF-SIMS was performed. As a result, the presence of the hydrophobic structure derived from the structural formula (1) was confirmed in each of the surface layer and the inner layer.

The foregoing showed that although the hydrophobicity of the mesoporous silica film subjected to a treatment with the steam of the hydrophobic modifying material in a state in which the humidity had not been sufficiently high was sufficient, an influence of an increase in refractive index in association with the introduction of the hydrophobic structure into the inner layer was large.

### Comparative Example 3

2.6 Grams of a tetraalkoxysilane, 0.7 g of a block copolymer (Pluronic P123, manufactured by BASF), 13 g of 1-propanol, and 1.35 g of a 0.01-M aqueous solution of hydrochloric acid were mixed and stirred. Thus, a sol reaction liquid was obtained. The sol reaction liquid was applied by a dip coating method onto a quartz substrate that had been washed with ultrapure water. Thus, an applied film was obtained.

After that, the substrate was baked in an electric furnace at 400° C. for 4 hours. Thus, a mesoporous silica thin film was obtained.

Next, the mesoporous silica thin film was left at rest in a vacuum reactor, and then the vacuum reactor was hermetically sealed. In the state, the pressure in the vacuum reactor was reduced with a vacuum pump, and then the vacuum reactor was sealed. Next, the steam of t-hexyldimethylchlorosilane represented by the structural formula (1) was introduced into the vacuum reactor, and then a hydrophobic treatment was performed for 10 hours.

After that, the inside of the vacuum reactor was sufficiently flowed with nitrogen. Then, the mesoporous silica thin film was taken out and subjected to a treatment for removing adsorbed water at 120° C. for 2 hours.

The mesoporous silica film was evaluated for its refractive index and thickness by spectroscopic ellipsometry. As a result, the film had a refractive index at a wavelength of 550 nm of 1.32 and a thickness of 112 nm. The mesoporous silica film was placed in a thermo-hygrostat under a 60° C., 90% RH environment. After a lapse of 100 hours, the film was left at rest under a room-temperature environment for an additional twenty-four hours. Even after that, nearly no fluctuation in refractive index was observed.

The surface layer and inner layer of the mesoporous silica film were each chemically analyzed in the same manner as in Example 1. As a result, an element ratio (A₁/S₁) of carbon to silicon in the surface layer was 0.3. In addition, an element ratio (A₂/S₂) of carbon to silicon in the inner layer was 0.3. In addition, analysis by TOF-SIMS was performed. As a result, the presence of the hydrophobic structure derived from the structural formula (1) was confirmed in each of the surface layer and the inner layer.

The foregoing showed that although the hydrophobicity of the mesoporous silica film subjected to a treatment with the steam of the hydrophobic modifying material in the vacuum reactor in a state in which moisture had insufficiently adsorbed to the insides of the fine pores was sufficient, an influence of an increase in refractive index in association with the introduction of the hydrophobic structure into the inner layer was large.

### Example 3

This example is as described below. Tetramethoxysilane (TMOS) was caused to react with a mesoporous silica film produced by using a polyethylene oxide-polypropylene oxide block copolymer as a template in a high humidity to form a nonporous silica layer on the surface of the film so that an antireflection film showing a stably low refractive index was produced.

5.7 Milliliters of tetraethoxysilane and 2.7 ml of 0.01-M hydrochloric acid were added to 7.6 ml of ethanol, and then the mixture was stirred for 20 minutes. A solution prepared by dissolving 1.4 g of the polyethylene oxide-polypropylene oxide block copolymer Pluronic P123 (BASF) in 5.1 ml of ethanol was added to the mixture, and then the whole was stirred for an additional three point five hours. Thus, a precursor sol solution was produced.

The precursor sol solution was applied by a spin coating method onto each of a silicon substrate (no doping, both surfaces had been polished) and a quartz glass substrate whose surfaces had been cleaned with a UV-ozone asher. Thus, an applied film was obtained. The spin coating was performed under the conditions of 1,000 revolutions for 10 seconds and then 3,000 revolutions for 40 seconds, and an atmosphere at the time of the spin coating had a temperature of 25° C. and a relative humidity of 40%. After having been dried at room temperature for 24 hours, the film was baked in air at 170° C. for 20 hours so that the surfactant was removed. Thus, a mesoporous silica film was obtained.

The mesoporous silica film was left at rest in a reactor having a temperature of 25° C. and a relative humidity of 40%, and then the reactor was hermetically sealed. In the state, the relative humidity in the reactor was increased to 90%, and then the temperature in the reactor was increased up to 60° C. at a rate of 0.1° C./min. While the temperature and the relative humidity in the reactor were kept at 60° C. and 90%, respectively, the steam of TMOS was introduced into the reactor, and then the mesoporous silica film was held in the atmosphere for 10 hours.

After the treatment had been performed, the atmosphere in the reactor was replaced with air so that the environment was returned to one having a temperature of 25° C. and a relative humidity of 40%. After that, the mesoporous silica film was taken out of the reactor.

Subsequently, the film was placed in an electric furnace. The temperature in the electric furnace was increased up to 150° C. at a rate of temperature increase of 1° C./min in air, and was then held at the value for 4 hours. After that, the temperature was further increased up to 400° C. at the same rate of temperature increase, and then baking was performed at 400° C. for 20 hours. Thus, a final mesoporous silica film was obtained.

The observation of a section of the mesoporous silica film with a high-resolution, field emission-type scanning electron microscope can confirm a two-layer configuration of the mesoporous silica film of a two-dimensional hexagonal structure having a thickness of about 200 nm and a silica layer having a thickness of about 20 nm formed on the surface of the film. It is confirmed that the surface silica layer is of a uniform contrast and has no porous structure.

The film on the silicon substrate was subjected to Fourier-transform infrared absorption spectroscopy. As a result, almost all silanol groups present in the mesoporous silica film were found to be only isolated silanol groups.

The mesoporous silica film formed on the quartz glass substrate was evaluated for its refractive index and thickness by spectroscopic ellipsometry. As a result, a refractive index at a wavelength of 550 nm and the thickness were determined to be 1.24 and 210 nm, respectively. The thickness coincides well with the result of the observation with the electron microscope. The mesoporous silica film was left to stand in a thermo-hygrostat under a 60° C., 90% RH environment for 100 hours, and was then left at rest under a room-temperature environment for an additional twenty-four hours. After that, the film was similarly evaluated by ellipsometry. As a result, it was confirmed that nearly no fluctuation in refractive index existed.

### Example 4

This example is as described below. Tetraethoxysilane (TEOS) was caused to react with a mesoporous silica film produced by using the same polyethylene oxide-polypropylene oxide block copolymer P123 as that of Example 3 as a template in a high humidity to form a nonporous silica layer on the surface of the film so that an antireflection film showing a stably low refractive index was produced.

An organic substance and an applied film were produced on each of a silicon substrate (no doping, both surfaces had been polished) and a quartz glass substrate by the same procedure as that of Example 3 with the same materials as those of Example 3 under the same conditions as those of Example 3. After having been dried at room temperature for 24 hours, the film was baked in air at 160° C. for 20 hours so that the surfactant was removed. Thus, a mesoporous silica film was obtained.

The mesoporous silica film was left at rest in a reactor having a temperature of 25° C. and a relative humidity of 40%, and then the reactor was hermetically sealed. In the state, the relative humidity in the reactor was increased to 80%, and then the temperature in the reactor was increased up to 70° C. at a rate of 0.1° C./min. While the temperature and the relative humidity in the reactor were kept at 70° C. and 80%, respectively, the steam of TEOS was introduced into the reactor, and then the mesoporous silica film was held in the atmosphere for 10 hours.

After the treatment had been performed, the atmosphere in the reactor was replaced with air so that the environment was returned to one having a temperature of 25° C. and a relative humidity of 40%. After that, the mesoporous silica film was taken out of the reactor.

Subsequently, the film was placed in an electric furnace. The temperature in the electric furnace was increased up to 150° C. at a rate of temperature increase of 1° C./min in air, and was then held at the value for 4 hours. After that, the temperature was further increased up to 200° C. at the same rate of temperature increase, and then baking was performed at 200° C. for 20 hours. Thus, a final mesoporous silica film was obtained.

The observation of a section of the mesoporous silica film with a high-resolution, field emission-type scanning electron microscope can confirm a two-layer configuration of the mesoporous silica film of a two-dimensional hexagonal structure having a thickness of about 250 nm and a silica layer having a thickness of about 20 nm formed on the surface of the film. It is confirmed that the surface silica layer is of a uniform contrast and has no porous structure.

The film on the silicon substrate was subjected to Fourier-transform infrared absorption spectroscopy. As a result, almost all silanol groups present in the mesoporous silica film were found to be only isolated silanol groups though the abundance thereof was larger than that in the case measured in Example 3.

The mesoporous silica film formed on the quartz glass substrate was evaluated for its refractive index and thickness by spectroscopic ellipsometry. As a result, a refractive index at a wavelength of 550 nm and the thickness were determined to be 1.26 and 270 nm, respectively.

The mesoporous silica film was left to stand in a thermo-hygrostat under a 60° C., 80% RH environment for 100 hours, and was then left at rest under a room-temperature environment for an additional twenty-four hours. After that, the film was similarly evaluated by ellipsometry. As a result, it was confirmed that nearly no fluctuation in refractive index existed.

### Example 5

This example is as described below. A mixed gas of tetramethoxysilane and tetrachlorosilane was caused to react with a mesoporous silica film produced by using a different polyethylene oxide-polypropylene oxide block copolymer from that of Example 3 as a template in a high humidity to form a nonporous silica layer on the surface of the film so that an antireflection film showing a stably low refractive index was produced.

5.7 Milliliters of tetraethoxysilane and 2.7 ml of 0.01-M hydrochloric acid were added to 7.6 ml of ethanol, and then the mixture was stirred for 20 minutes. A solution prepared by dissolving 2.8 g of a polyethylene oxide-polypropylene oxide block copolymer Pluronic F127 (BASF) in 5.1 ml of ethanol was added to the mixture, and then the whole was stirred for an additional three point five hours. Thus, a precursor sol solution was produced.

The precursor sol solution was applied by a spin coating method onto each of a silicon substrate (no doping, both surfaces had been polished) and a quartz glass substrate whose surfaces had been cleaned with a UV-ozone asher. Thus, an applied film was obtained. The spin coating was performed under the conditions of 1,000 revolutions for 10 seconds and then 3,500 revolutions for 30 seconds, and an atmosphere at the time of the spin coating had a temperature of 25° C. and a relative humidity of 40%. After having been dried at room temperature for 24 hours, the film was baked in air at 170° C. for 20 hours so that the surfactant was removed. Thus, a mesoporous silica film was obtained.

The mesoporous silica film was left at rest in a reactor having a temperature of 25° C. and a relative humidity of 40%, and then the reactor was hermetically sealed. In the state, the relative humidity in the reactor was increased to 90%, and then the temperature in the reactor was increased up to 60° C. at a rate of 0.1° C./min. While the temperature and the relative humidity in the reactor were kept at 60° C. and 90%, respectively, mixed steam of tetrachlorosilane and tetramethoxysilane (TMOS) was introduced into the reactor, and then the mesoporous silica film was held in the atmosphere for 10 hours.

After the treatment had been performed, the atmosphere in the reactor was replaced with air so that the environment was returned to one having a temperature of 25° C. and a relative humidity of 40%. After that, the mesoporous silica film was taken out of the reactor.

Subsequently, the film was placed in an electric furnace. The temperature in the electric furnace was increased up to 150° C. at a rate of temperature increase of 1° C./min in air, and was then held at the value for 4 hours. After that, the temperature was further increased up to 400° C. at the same rate of temperature increase, and then baking was performed at 400° C. for 20 hours. Thus, a final mesoporous silica film was obtained.

The observation of a section of the mesoporous silica film with a high-resolution, field emission-type scanning electron microscope was able to confirm a two-layer configuration of the mesoporous silica film of a cubic structure having a thickness of about 180 nm and a silica layer having a thickness of about 20 nm formed on the surface of the film. It is confirmed that the surface silica layer is of a uniform contrast and has no porous structure.

The film on the silicon substrate was subjected to Fourier-transform infrared absorption spectroscopy. As a result, almost all silanol groups present in the mesoporous silica film were found to be only isolated silanol groups.

The mesoporous silica film formed on the quartz glass substrate was evaluated for its refractive index and thickness by spectroscopic ellipsometry. As a result, a refractive index at a wavelength of 550 nm and the thickness were determined to be 1.25 and 200 nm, respectively. The thickness coincides well with the result of the observation with the electron microscope. The mesoporous silica film was left to stand in a thermo-hygrostat under a 60° C., 90% RH environment for 100 hours, and was then left at rest under a room-temperature environment for an additional twenty-four hours. After that, the film was similarly evaluated by ellipsometry. As a result, it was confirmed that nearly no fluctuation in refractive index existed.

### Example 6

This example is as described below. TMOS was caused to react with a mesoporous silica film having a different fine pore structure produced by using the same polyethylene oxide-polypropylene oxide block copolymer P123 as those of Examples 3 and 4 as a template in a high humidity to form a nonporous silica layer on the surface of the film so that an antireflection film showing a stably low refractive index was produced.

2.8 Milliliters of tetraethoxysilane were added to and dissolved in 9.7 ml of 1-propanol. A solution prepared by dissolving 1.4 ml of 0.01-M hydrochloric acid and 0.7 g of the polyethylene oxide-polypropylene oxide block copolymer Pluronic P123 (BASF) in 6.5 ml of 1-propanol was added to the resultant solution, and then the mixture was stirred for an additional twenty-four hours. After that, 8.0 ml of ethanol were further added to the mixture. Thus, a precursor sol solution was produced.

The precursor sol solution was applied by a spin coating method onto each of a silicon substrate (no doping, both surfaces had been polished) and a quartz glass substrate whose surfaces had been cleaned with a UV-ozone asher. Thus, an applied film was obtained. The spin coating was performed under the conditions of 1,000 revolutions for 10 seconds and then 3,500 revolutions for 60 seconds, and an atmosphere at the time of the spin coating had a temperature of 25° C. and a relative humidity of 40%. After having been dried at room temperature for 24 hours, the film was baked in air at 170° C. for 20 hours so that the surfactant was removed. Thus, a mesoporous silica film was obtained.

The mesoporous silica film was left at rest in a reactor having a temperature of 25° C. and a relative humidity of 40%, and then the reactor was hermetically sealed. In the state, the relative humidity in the reactor was increased to 90%, and then the temperature in the reactor was increased up to 60° C. at a rate of 0.1° C./min. While the temperature and the relative humidity in the reactor were kept at 60° C. and 90%, respectively, the steam of TMOS was introduced into the reactor, and then the mesoporous silica film was held in the atmosphere for 10 hours.

After the treatment had been performed, the atmosphere in the reactor was replaced with air so that the environment was returned to one having a temperature of 25° C. and a relative humidity of 40%. After that, the mesoporous silica film was taken out of the reactor.

Subsequently, the film was placed in an electric furnace. The temperature in the electric furnace was increased up to 150° C. at a rate of temperature increase of 1° C./min in air, and was then held at the value for 4 hours. After that, the temperature was further increased up to 400° C. at the same rate of temperature increase, and then baking was performed at 400° C. for 20 hours. Thus, a final mesoporous silica film was obtained.

The observation of a section of the mesoporous silica film with a high-resolution, field emission-type scanning electron microscope was able to confirm a two-layer configuration of the mesoporous silica film of a wormhole structure having a thickness of about 150 nm and a silica layer having a thickness of about 20 nm formed on the surface of the film. It is confirmed that the surface silica layer is of a uniform contrast and has no porous structure.

The film on the silicon substrate was subjected to Fourier-transform infrared absorption spectroscopy. As a result, almost all silanol groups present in the mesoporous silica film were found to be only isolated silanol groups.

The mesoporous silica film formed on the quartz glass substrate was evaluated for its refractive index and thickness by spectroscopic ellipsometry. As a result, a refractive index at a wavelength of 550 nm and the thickness were determined to be 1.24 and 160 nm, respectively. The thickness coincides well with the result of the observation with the electron microscope.

The mesoporous silica film was left to stand in a thermo-hygrostat under a 60° C., 90% RH environment for 100 hours, and was then left at rest under a room-temperature environment for an additional twenty-four hours. After that, the film was similarly evaluated by ellipsometry. As a result, it was confirmed that nearly no fluctuation in refractive index existed.

### Comparative Example 4

In the same manner as in Example 3, 5.7 ml of tetraethoxysilane and 2.7 ml of 0.01-M hydrochloric acid were added to 7.6 ml of ethanol, and then the mixture was stirred for 20 minutes. A solution prepared by dissolving 1.4 g of the polyethylene oxide-polypropylene oxide block copolymer Pluronic P123 (BASF) in 5.1 ml of ethanol was added to the mixture, and then the whole was stirred for an additional three point five hours. Thus, a precursor sol solution was produced.

The precursor sol solution was applied by a spin coating method onto a quartz glass substrate whose surface had been cleaned with a UV-ozone asher. Thus, an applied film was obtained. The spin coating was performed under the conditions of 1,000 revolutions for 10 seconds and then 3,000 revolutions for 40 seconds, and an atmosphere at the time of the spin coating had a temperature of 25° C. and a relative humidity of 40%. After having been dried at room temperature for 24 hours, the film was baked in air at 400° C. for 20 hours so that the surfactant was removed. Thus, a mesoporous silica film was obtained.

The observation of a section with a scanning electron microscope confirmed that the film was a mesoporous silica of a two-dimensional hexagonal structure having a thickness of about 150 nm.

The mesoporous silica film was evaluated for its refractive index and thickness by spectroscopic ellipsometry. As a result, a refractive index at a wavelength of 550 nm and the thickness were determined to be 1.22 and 160 nm, respectively. The mesoporous silica film was placed in a thermo-hygrostat under a 60° C., 90% RH environment. After a lapse of 100 hours, the film was left at rest under a room-temperature environment for 24 hours. After that, the refractive index was measured again. As a result, the refractive index increased to 1.28.

The foregoing shows that a fluctuation in the refractive index of a simple mesoporous silica film on which the surface nonporous silica layer of the present invention is not formed occurs owing to moisture absorption.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2010-144282, filed Jun. 24, 2010, and 2011-132193, filed Jun. 14, 2011, which are hereby incorporated by reference herein in their entirety.

1. A mesoporous silica film, comprising a structure represented by SiO_{(2-n/2)}Xₙ where X represents a group formed of at least one kind selected from the group consisting of an alkyl group, a fluorinated alkyl group, and fluorine, n represents an integer of 1 or more and 3 or less, and, in a case where X represents an alkyl group or a fluorinated alkyl group, the group is allowed to have an unsaturated bond in part of the group in a surface layer as a region to a depth of less than 10 nm from at least one surface of the mesoporous silica film,
wherein:
an element component ratio (A₁/S₁) of sum of number of carbon atoms and number of fluorine atoms (A₁) to number of silicon atoms (S₁) in the surface layer is 0.1 or more; and
an element component ratio (A₂/S₂) of sum of number of carbon atoms and number of fluorine atoms (A₂) to number of silicon atoms (S₂) in an inner layer as a region to a depth of 10 nm or more from the surface of the mesoporous silica film is smaller than the element component ratio (A₁/S₁) of sum of number of carbon atoms and number of fluorine atoms to number of silicon atoms in the surface layer.

2. The mesoporous silica film according to claim 1, wherein the element component ratio (A₂/S₂) of sum of number of carbon atoms and number of fluorine atoms to number of silicon atoms in the inner layer of the mesoporous silica film is 25% or less of the element component ratio (A₁/S₁) of sum of number of carbon atoms and number of fluorine atoms to number of silicon atoms in the surface layer of the mesoporous silica film.

3. A structural body having a mesoporous silica film, comprising a structure represented by SiO_{(2-n/2)}Xₙ where X represents a group formed of at least one kind selected from the group consisting of an alkyl group, a fluorinated alkyl group, and fluorine, n represents an integer of 1 or more and 3 or less, and, in a case where X represents an alkyl group or a fluorinated alkyl group, the group is allowed to have an unsaturated bond in part of the group in a surface layer as a region to a depth of less than 10 nm from the surface of the mesoporous silica film,
wherein:
an element component ratio (A₁/S₁) of sum of number of carbon atoms and number of fluorine atoms (A₁) to number of silicon atoms (S₁) in the surface layer is 0.1 or more; and
an element component ratio (A₂/S₂) of sum of number of carbon atoms and number of fluorine atoms (A₂) to number of silicon atoms (S₂) in an inner layer as a region to a depth of 10 nm or more from the surface of the mesoporous silica film is smaller than the element component ratio (A₁/S₁) of sum of number of carbon atoms and number of fluorine atoms to number of silicon atoms in the surface layer.

4. The structural body according to claim 3, wherein the element component ratio (A₂/S₂) of sum of number of carbon atoms and number of fluorine atoms to number of silicon atoms in the inner layer of the mesoporous silica film is 25% or less of the element component ratio (A₁/S₁) of sum of number of carbon atoms and number of fluorine atoms to number of silicon atoms in the surface layer of the mesoporous silica film.

5. An antireflection film having a mesoporous silica film, comprising a structure represented by SiO_{(2-n/2)}Xₙ where X represents a group formed of at least one kind selected from the group consisting of an alkyl group, a fluorinated alkyl group, and fluorine, n represents an integer of 1 or more and 3 or less, and, in a case where X represents an alkyl group or a fluorinated alkyl group, the group is allowed to have an unsaturated bond in part of the group in a surface layer as a region to a depth of less than 10 nm from the surface of the mesoporous silica film,
wherein:
an element component ratio (A₁/S₁) of sum of number of carbon atoms and number of fluorine atoms (A₁) to number of silicon atoms (S₁) in the surface layer is 0.1 or more; and
an element component ratio (A₂/S₂) of sum of number of carbon atoms and number of fluorine atoms (A₂) to number of silicon atoms (S₂) in an inner layer as a region to a depth of 10 nm or more from the surface of the mesoporous silica film is smaller than the element component ratio (A₁/S₁) of sum of number of carbon atoms and number of fluorine atoms to number of silicon atoms in the surface layer.

6. The antireflection film according to claim 5, wherein the element component ratio (A₂/S₂) of sum of number of carbon atoms and number of fluorine atoms to number of silicon atoms in the inner layer of the mesoporous silica film is 25% or less of the element component ratio (A₁/S₁) of sum of number of carbon atoms and number of fluorine atoms to number of silicon atoms in the surface layer of the mesoporous silica film.

7. An optical member comprising an antireflection film, wherein the antireflection film comprises the antireflection film according to claim 5.

8. A method of producing a treated mesoporous silica film, comprising:
(1) exposing a mesoporous silica film to an environment having a relative humidity of 80% or more in a reactor in which a relative humidity is controllable to cause insides of fine pores of the mesoporous silica film to adsorb moisture;
(2) introducing steam containing a silicon-containing compound into the reactor in a state in which moisture adsorbs to the insides of the fine pores of the mesoporous silica film; and
(3) treating the mesoporous silica film with the silicon-containing compound and then taking the mesoporous silica film out of the reactor to desorb moisture adsorbing to the insides of the fine pores.

9. The method of producing a treated mesoporous silica film according to claim 8, wherein the silicon-containing compound comprises a compound represented by SiXₓY₍₄₋ₙ₎ where X represents a group formed of at least one kind selected from the group consisting of an alkyl group, a fluorinated alkyl group, and fluorine, Y represents a group formed of one or more kinds selected from the group consisting of chlorine, bromine, alkoxyl group, and a hydroxyl group, n represents an integer of 1 to 3, and, in a case where X represents an alkyl group or a fluorinated alkyl group, the group is allowed to have an unsaturated bond in part of the group.

10. The method of producing a treated mesoporous silica film according to claim 8, wherein hydrophobicity of the mesoporous silica film is improved by the treatment.

11. The method of producing a treated mesoporous silica film according to claim 8, wherein the silicon-containing compound comprises a compound having a structure represented by SiA₄ where A represents a chlorine, a bromineor an alkoxy group.

12. The method of producing a treated mesoporous silica film according to claim 8, comprising forming a nonporous silica layer on a surface of the mesoporous silica film by the treatment.

13. The method of producing a treated mesoporous silica film according to claim 11, further comprising:
applying a precursor solution containing a surfactant and a silica source to a base material and drying the solution at a temperature of 170° C. or less to provide the mesoporous silica film prior to the causing of the insides of the fine pores of the mesoporous silica film to adsorb moisture; and
baking the treated mesoporous silica film at a temperature of 170° C. or more in the state in which moisture adsorbs to the insides of the fine pores of the mesoporous silica film after the introduction of the steam containing the silicon-containing compound into the reactor.

14. The method of producing a treated mesoporous silica film according to claim 13, wherein the baking is performed at a temperature of 300° C. or more.

15. A method of producing a treated mesoporous silica film, comprising:
(1) reducing a pressure in a reactor whose pressure is capable of being reduced in a state in which a mesoporous silica film and water coexist in the reactor to form an environment where a gas having a highest partial pressure in the reactor comprises water vapor and then sealing the reactor to cause insides of fine pores of the mesoporous silica film to adsorb moisture;
(2) introducing steam containing a silicon-containing compound into the reactor in a state in which moisture adsorbs to the insides of the fine pores of the mesoporous silica film; and
(3) treating the mesoporous silica film with the silicon-containing compound and then taking the mesoporous silica film out of the reactor to desorb moisture adsorbing to the insides of the fine pores.

16. The method of producing a treated mesoporous silica film according to claim 15, wherein the silicon-containing compound comprises a compound represented by SiXₙY₍₄₋ₙ₎ where X represents a group formed of at least one kind selected from the group consisting of an alkyl group, a fluorinated alkyl group, and fluorine, Y represents a group formed of one or more kinds selected from the group consisting of chlorine, bromine, alkoxyl group, and a hydroxyl group, n represents an integer of 1 to 3, and, in a case where X represents an alkyl group or a fluorinated alkyl group, the group is allowed to have an unsaturated bond in part of the group.

17. The method of producing a treated mesoporous silica film according to claim 15, wherein hydrophobicity of the mesoporous silica film is improved by the treatment.

18. The method of producing a treated mesoporous silica film according to claim 15, wherein the silicon-containing compound comprises a compound having a structure represented by SiA₄ where A represents a chlorine, a bromine or an alkoxy group.

19. The method of producing a treated mesoporous silica film according to claim 15, comprising forming a nonporous silica layer on a surface of the mesoporous silica film by the treatment.

20. The method of producing a treated mesoporous silica film according to claim 18, further comprising:
applying a precursor solution containing a surfactant and a silica source to a base material and drying the solution at a temperature of 170° C. or less to provide the mesoporous silica film prior to the causing of the insides of the fine pores of the mesoporous silica film to adsorb moisture; and
baking the treated mesoporous silica film at a temperature of 170° C. or more in the state in which moisture adsorbs to the insides of the fine pores of the mesoporous silica film after the introduction of the steam containing the silicon-containing compound into the reactor.

21. The method of producing a treated mesoporous silica film according to claim 20, wherein the baking is performed at a temperature of 300° C. or more.

22. A method of producing a structural body having a mesoporous silica film, comprising forming the mesoporous silica film by the method according to claim 8.

23. A method of producing an antireflection film having a mesoporous silica film, comprising forming the mesoporous silica film by the method according to claim 8.

24. A method of producing an optical member having an antireflection film having a mesoporous silica film, comprising forming the mesoporous silica film by the method according to claim 8.
